(19) United States
(12) Patent Application Publication
(10) Pub. No.: US 2008/0204618 A1
(43) Pub. Date: Aug. 28, 2008

(54) DISPLAY SUBSTRATE, METHOD FOR MANUFACTURING THE SAME, AND DISPLAY APPARATUS HAVING THE SAME

(76) Inventors: Min-Kyung JUNG, Suwon-si (KR); Yong-Han Park, Anyang-si (KR); Hyung-Don Na, Seoul (KR); Hyun-Young Kim, Suwon-si (KR)

Correspondence Address: F. CHAU & ASSOCIATES, LLC, 130 WOODBURY ROAD, WOODBURY, NY, 11797, US

(21) Appl. No.: 12/034,049

(22) Filed: Feb. 20, 2008

(30) Foreign Application Priority Data
Feb. 22, 2007 (KR) 2007-17643
May 22, 2007 (KR) 2007-49539

(51) Int. Cl. G02F 1/1343; G02F 1/133

(52) U.S. Cl. 349/40; 349/150; 349/152

(57) ABSTRACT

A display substrate includes a substrate, a guard ring and a connecting line. The substrate includes a plurality of active areas, and each of the active areas has a pixel area and a peripheral area. The guard ring is formed on the substrate to enclose each of the active areas, and is formed from substantially the same layer as a pixel electrode that is formed in a unit pixel. The connecting line is formed from a different layer than the guard ring, to electrically connect the guard ring with pads. The connecting line is formed before forming an organic insulating layer, and thus the frequency and/or severity of patterning defects of the connecting line may be reduced or prevented. Accordingly, short circuits between the pads may be prevented, and the corrosion resistance of the display apparatus may be increased.

### CROSS-REFERENCE TO RELATED APPLICATIONS

This application claims priority under 35 U.S.C. §119 to Korean Patent Applications No. 10-2007-0017643, filed on Feb. 22, 2007, and No. 10-2007-0049539, filed on May 22, 2007, the contents of which are herein incorporated by reference in their entireties.

### BACKGROUND OF THE INVENTION

1. Technical Field

The present invention relates to a display substrate. More particularly, the present invention relates to a display substrate, a method for manufacturing the same and a display apparatus having the same.

2. Discussion of the Related Art

Methods for manufacturing a display substrate of a liquid crystal display (LCD) panel may include a rubbing process for forming textures extending along a predetermined direction on an alignment film. The rubbing process may cause static electricity to discharge on the display apparatus. For example, rubbing a negatively charged cloth against a positively charged display substrate may cause electrostatic discharge that may damage the display apparatus. Accordingly, defects due to electrostatic discharge may occur in the display substrate, and the defects may mainly occur at a portion through which a metal thin film formed on the display substrate is exposed. Thus, methods for manufacturing the display substrate have included forming a guard ring at an edge of the display substrate from substantially the same material as a pixel electrode, so that static electricity is dissipated over the entire substrate. However, when the display substrate includes the guard ring, defects of the display substrate may occur more frequently and/or with greater severity.

### SUMMARY OF THE INVENTION

Exemplary embodiments of the present invention provide a display substrate capable of decreasing a frequency and/or severity of defects due to electrostatic discharge.

Exemplary embodiments of the present invention provide a method for manufacturing a display substrate capable of decreasing the frequency and/or severity of defects due to electrostatic discharge.

Exemplary embodiments of the present invention provide a display apparatus decreasing the frequency and/or severity of defects due to electrostatic discharge.

Exemplary embodiments of the present invention provide a display apparatus having good corrosion resistance.

A display substrate according to an exemplary embodiment of the present invention includes a substrate, a guard ring and a connecting line. The substrate includes a plurality of active areas, and each of the active areas has a pixel area in which a plurality of unit pixels are defined and a peripheral area in which pads applying signals to the pixel areas are formed. The guard ring is formed on the substrate to enclose each of the active areas, and is formed from substantially a same layer as a pixel electrode that is formed in the unit pixels. The connecting line is formed from a different layer than the guard ring, to electrically connect the guard ring with the pad.

A method for manufacturing a display substrate according to an exemplary embodiment of the present invention includes forming a first metal pattern including a gate line on a substrate. The active area has a pixel area and a peripheral area defined in the substrate. A first insulating layer is formed on the substrate on which the first metal pattern is formed. A second metal pattern including a data line is formed on the first insulating layer. A second insulating layer is formed on the substrate on which the second metal pattern is formed. A guard ring is formed on the second insulating layer, and the guard ring encloses a pixel electrode corresponding to a unit pixel and the active area. Pads including a first pad layer are formed in the peripheral area, and the first pad layer is formed from at least one of the first and second metal patterns. A connecting line is formed from a different layer from the guard ring, and the connecting line electrically connects the guard ring with the pad.

A display apparatus according to an exemplary embodiment of the present invention includes a first substrate and a connecting line remaining portion. The first substrate has a pixel area, in which a plurality of unit pixels are defined, and a peripheral area, in which pads applying a signal to the pixel area are formed. The connecting line remaining portion is connected to each pad to extend toward an edge of the first substrate, and is cut at an edge of the first substrate. The connecting line remaining portion is formed from a different layer from a guard ring. The guard ring is formed on a motherboard for a first substrate to enclose the first substrate. In this case, the connecting line remaining portion is formed by cutting the guard ring enclosing the first substrate and the connecting line electrically connecting the pads with each other, by the use of a scribing process.

A display apparatus according to an exemplary embodiment of the present invention includes a first display panel, a second display panel and a flexible printed circuit board (FPCB). A driving chip is mounted on the first display panel. The second display panel includes a first connecting line electrically connected to an FPC pad that is formed at an edge of a data line, a second connecting line spaced apart from the first connecting line and electrically connected to a shorting bar that is formed at an outer area of a base substrate, and a bridge connecting the first connecting line with the second connecting line. The FPCB electrically connects the first display panel with the second display panel and is electrically connected to the FPC pad, to transmit a driving signal from the driving chip to the second display panel.

A display apparatus according to an exemplary embodiment of the present invention includes a first display panel, a second display panel and an FPCB. A driving chip is mounted on the first display panel. The second display panel includes a connecting line electrically connecting an FPC pad with a shorting bar, the FPC pad having a metal pad layer formed at an edge of a data line and an electrode pattern formed from a transparent conductive layer on the metal pad layer. The shorting bar is formed from the transparent conductive layer at an outer area of the electrode pattern and a base substrate. The FPCB electrically connects the first display panel with the second display panel and is electrically connected to each FPC pad, to transmit a driving signal from the driving chip to the second display panel.

According to an exemplary embodiment of the present invention, the connecting line electrically connecting the guard ring with the pad is formed before forming the second insulating layer, so that the frequency and/or severity of patterning defects of the connecting line caused at a stepped portion of the second insulating layer may be reduced or prevented. Thus, short circuits between the pads may be prevented, and static electricity that flows from the pad in a manufacturing process may be efficiently dissipated through the guard ring.

In addition, the second connecting line making contact with the shorting bar is connected to the first connecting line by the bridge, or the FPC pad and the shorting bar are electrically connected with each other by the connecting line, so that corrosion of the data line may be minimized and the corrosion resistance of the display apparatus may be increased.

### BRIEF DESCRIPTION OF THE DRAWINGS

The above and other features and aspects of the exemplary embodiments of the present invention are described in detail below with reference to the accompanying drawings, in which:

FIG. 1 is a plan view illustrating a display substrate according to an exemplary embodiment of the present invention;

FIG. 2 is an enlarged plan view illustrating a portion “A” in FIG. 1 according to an exemplary embodiment of the present invention;

FIG. 3 is a cross-sectional view taken along lines I-I′ and II-II′ of FIG. 2;

FIGS. 4 to 9 are cross-sectional views illustrating a method for manufacturing a display substrate according to an exemplary embodiment of the present invention;

FIG. 10 is an enlarged plan view illustrating a portion “A” in FIG. 1 according to an exemplary embodiment of the present invention;

FIG. 11 is a cross-sectional view taken along lines III-III′ and IV-IV′ of FIG. 10;

FIGS. 12 to 18 are cross-sectional views illustrating a method for manufacturing a display substrate according to an exemplary embodiment of the present invention;

FIG. 19 is a plan view illustrating a display apparatus according to an exemplary embodiment of the present invention;

FIG. 20 is an enlarged plan view illustrating a portion “B” in FIG. 19;

FIG. 21 is a plan view illustrating a display apparatus according to an exemplary embodiment of the present invention;

FIG. 22 is an enlarged plan view illustrating a second display panel according to an exemplary embodiment of the display apparatus in FIG. 21;

FIG. 23 is a cross-sectional view taken along lines V-V′ and VI-VI′ of FIG. 22;

FIG. 24 is an enlarged plan view illustrating a second display panel according to an exemplary embodiment of the display apparatus in FIG. 21; and

FIG. 25 is a cross-sectional view taken along lines V-V′ and VI-VI′ of FIG. 24.

### DETAILED DESCRIPTION OF EXEMPLARY EMBODIMENTS

Exemplary embodiments of the present invention are described more fully hereinafter with reference to the accompanying drawings. This invention may, however, be embodied in many different forms and should not be construed as limited to the embodiments set forth herein. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present.

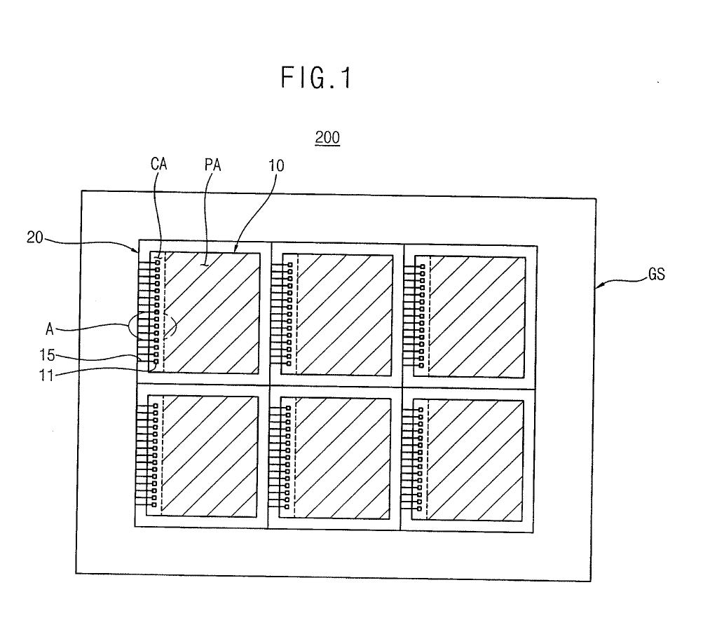

FIG. 1 is a plan view illustrating a display substrate 200 according to an exemplary embodiment of the present invention.

Referring to FIG. 1, the display substrate 200 includes a base substrate GS. An active area 10 is defined in the base substrate GS.

The active area 10 includes a pixel area PA and a peripheral area CA. Unit pixels including a thin-film transistor and a pixel electrode are defined in the pixel area PA. A driving signal is applied to the pixel area PA from the peripheral area CA.

A printed circuit board (PCB) generates a control signal to control an image. A flexible PCB (FPCB) electrically connects the PCB with the pixel area PA. A driving chip changing the control signal into a driving signal, is disposed in the peripheral area CA. Furthermore, a plurality of pads 11 such as integrated circuit (IC) pads electrically connects the driving chip with the data line. FPC pads attaching the FPCB to the substrate, are formed in the peripheral area CA.

In addition, a guard ring 20 is formed on the base substrate GS to enclose each active area 10, so that static electricity generated in a manufacturing process may be dissipated to the entire base substrate GS. Each guard ring 20 enclosing each active area 10 is electrically connected with each other.

The active area 10 of the display substrate 200 is substantially used for a display apparatus such as a liquid crystal display (LCD) apparatus. The active area 10 is cut by a scribing process, to be used for an array substrate of the display apparatus.

Thus, an area in which the guard ring 20 is formed is not used after the scribing process, and a connecting line 15 is cut by the scribing process.

A plurality of display apparatuses using the active areas 10 as the array substrates are manufactured by the scribing process, and a portion of the connecting line 15 remains in each display apparatus.

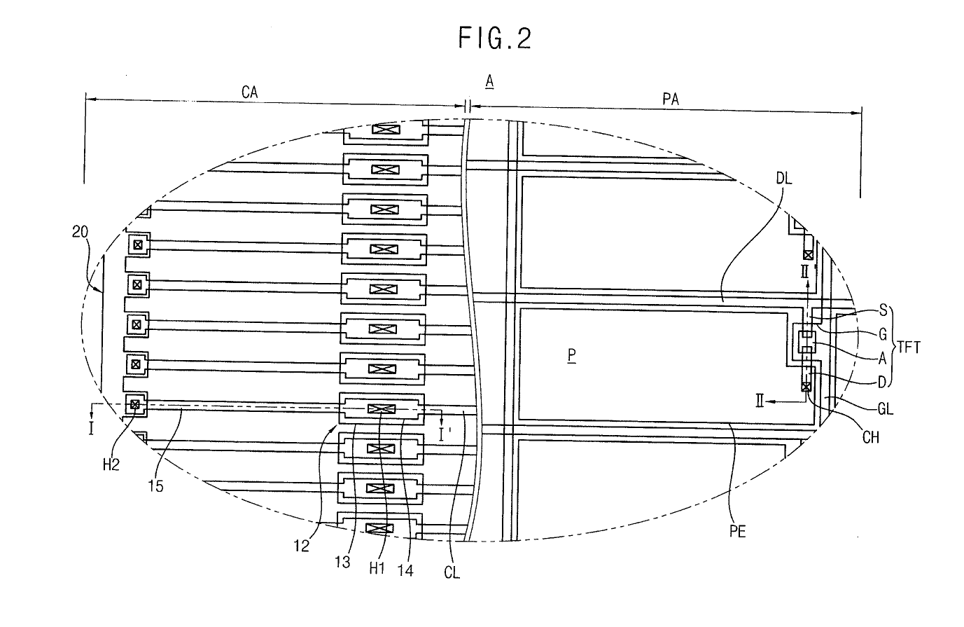

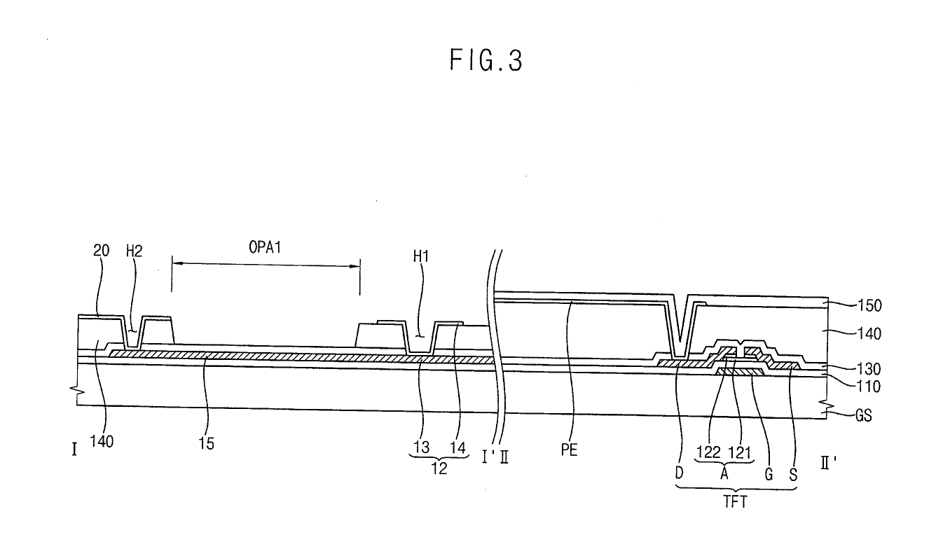

FIG. 2 is an enlarged plan view illustrating a portion “A” in FIG. 1 according to an exemplary embodiment of the display substrate. FIG. 3 is a cross-sectional view taken along lines I-I′ and II-II′ of FIG. 2.

Referring to FIGS. 1 to 3, gate lines GL extend along a first direction and data lines DL extend along a second direction, substantially perpendicular to the first direction, in the pixel area PA. In addition, a plurality of unit pixels P is defined in the pixel area PA. The gate line GL is formed on the base substrate GS, and is formed from a first metal pattern. A gate insulating layer 110 is formed on the base substrate GS on which the first metal pattern is formed. The gate insulating layer 110 may include silicon nitride (SiNx) or silicon oxide (SiOx).

The data line DL is formed on the gate insulating layer 110, and is formed form a second metal pattern. A thin-film transistor TFT that is a switching element and the pixel electrode PE electrically connected to the thin-film transistor TFT are formed in the unit pixel P.

For example, each thin-film transistor TFT includes a gate electrode G, a channel layer A, a source electrode S and a drain electrode D. The gate electrode G is formed from substantially the same layer as the first metal pattern protruded from the gate line GL.

The channel layer A is formed on the gate insulating layer 110 to overlap with the gate electrode G. For example, a semiconductor layer 121 having amorphous silicon and an ohmic contact layer 122 having amorphous silicon doped with ions, are integrated to form the channel layer A.

The source electrode S is the second metal pattern protruded from the data line DL. In this case, the source electrode S partially overlaps with the channel layer A. The drain electrode D is formed from the second metal pattern as the source electrode S, and is spaced apart from the source electrode S by a predetermined distance to partially overlap with the channel layer A.

A portion of the ohmic contact layer 122 between the source electrode S and the drain electrode D is removed, to expose the semiconductor layer 121.

A passivation layer 130 is formed on the base substrate GS on which the thin-film transistor TFT is formed. For example, the passivation layer 130 may include silicon nitride (SiNx) or silicon oxide (SiOx). In addition, an organic insulating layer 140 including an organic material is formed on the passivation layer 130. A contact hole CH is formed through the passivation layer 130 and the organic insulating layer 140 to expose a portion of the drain electrode D. For example, the organic insulating layer 140 corresponding to the peripheral area CA has a relatively thin thickness, so that the driving elements such as the driving chip, the FPCB, may be easily attached to the peripheral area CA.

The pixel electrode PE corresponds to the unit pixel P and is formed on the organic insulating layer 140. The pixel electrode PE includes a transparent conductive material. For example, the pixel electrode PE may include indium tin oxide (ITO), indium zinc oxide (IZO), amorphous ITO and so on. The pixel electrode PE is electrically connected to the drain electrode D through the contact hole CH that is formed through the passivation layer 130 and the organic insulating layer 140.

As described referring to FIG. 1, a plurality of pads 11 such as the IC pads electrically connecting the driving chip with the data line DL and the FPC pads attaching the FPCB to the display substrate 200, are formed in the peripheral area CA. In this case, the FPC pad 12, as an example of the pads 11, is illustrated in FIGS. 2 and 3 and will be explained with additional reference numbers.

For example, the FPC pad 12 is formed from substantially the same layer as the first metal pattern forming the gate line GL, and includes a metal pad layer 13 and a transparent pad layer 14. The metal pad layer 13 is formed from at least one second metal pattern forming the data line. The transparent pad layer 14 is electrically connected to the metal pad layer 13 and is formed from substantially the same layer as the pixel electrode PE.

In FIG. 3, the metal pad layer 13 is formed from the second metal pattern. For example, the metal pad layer 13 may be formed exclusively from the second metal pattern. Alternatively, the second metal pattern is integrated on the first metal pattern to form the metal pad layer 13. When the second metal pattern is integrated on the first metal pattern to form the metal pad layer 13, a hole through which the first metal pattern is electrically connected to the second metal pattern is formed through the gate insulating layer 110.

The passivation layer 130 and the organic insulating layer 140 are formed between the metal pad layer 13 and the transparent pad layer 14, and a first hole H1 is formed through the passivation layer 130 and the organic insulating layer 140 to partially expose the metal pad layer 13.

The transparent pad layer 14 makes contact with the metal pad layer 13 through the first hole H1, and preferably has an area larger than the metal pad layer 13.

An alignment film 150 may be further formed on the base substrate GS on which the pixel electrode PE and the transparent electrode layer 14 are formed, so that liquid crystal molecules are arranged along a predetermined direction. The alignment film 150 is only formed in the pixel area PA making contact with a liquid crystal layer having the liquid crystal molecules. Textures extending along a predetermined direction are formed on a surface of the alignment film 150 to arrange the liquid crystal molecules. A process for manufacturing the display substrate includes a rubbing process. In the rubbing process, the alignment film 150 is rubbed by a rubbing cloth to form the textures. However, static electricity is generated during the rubbing process, and the static electricity occurs more frequently in an area where the conductive material, such as that of the pads 11, is exposed to a surface of the display substrate.

Accordingly, as explained above with reference to FIG. 1, the guard ring 20 is formed on the display substrate 200, so that the static electricity may be dissipated over the entire surface of the display substrate 200, and thus the active area 10 may be protected. The guard ring 20 encloses each active area 10, and is formed from substantially the same layer as the pixel electrode PE and the transparent electrode layer 14. The guard ring 20 is electrically connected to the FPC pad 12 through the connecting line 15, and electric charges in the FPC pad 12 are dissipated to the guard ring 20 through the connecting line 15 when static electricity is generated.

A first opening pattern OPA1 corresponding to the guard ring 20 and the FPC pads 12 is formed through the organic insulating layer 140, so that the FPCB may be easily attached.

Therefore, a stepped portion having a height substantially the same as a thickness of the organic insulating layer 140 is formed between the guard ring 20 and the FPC pads 12. The connecting line 15 may be formed from substantially the same layer as the transparent electrode layer 14 and the guard ring 20. However, when the first opening pattern OPA1 of the organic insulating layer 140 forms the stepped portion, the transparent conductive material forming the connecting line 15 may remain at an edge of the first opening pattern OPA1, thereby causing patterning defects of the connecting line 15. When the patterning defects of the connecting line 15 occurs, short circuits between the FPC pads 12 may occur, so that the static electricity generated in the process for manufacturing the display substrate may be prevented from being dissipated.

Accordingly, in exemplary embodiments of the present invention, the connecting line 15 is formed before forming the organic insulating layer 140, and the frequency and/or severity of patterning defects of the connecting line may be reduced and/or prevented.

For example, the connecting line 15 according to the present exemplary embodiment is formed from the second metal pattern and directly connects to the metal pad layer 13 of the FPC pad.

A second hole H2 is formed through the passivation layer 130 and the organic insulating layer 140 so that the guard ring 20 makes contact with the connecting line 15 through the second hole H2. Accordingly, each FPC pad 12 is electrically connected to each guard ring 20, and the static electricity in the FPC pad 12 is dissipated to the guard ring 20 along the connecting line 15 formed from the second metal pattern.

According to the present exemplary embodiment, the connecting line 15 is formed before forming the organic insulating layer 140, so that short circuits between the FPC pads 12 due to the patterning defects of the connecting line 15 may be reduced and/or prevented and static electricity may be efficiently dissipated. Thus, the frequency and/or severity of defects due to electrostatic discharge may be decreased.

The connecting line 15 connecting the FPC pad 12 and the guard ring 20 has been described with respect to the present exemplary embodiment, but the present invention is not limited to such a connecting line. For example, a connecting line may connect pads formed in the peripheral area CA with the guard ring 20.

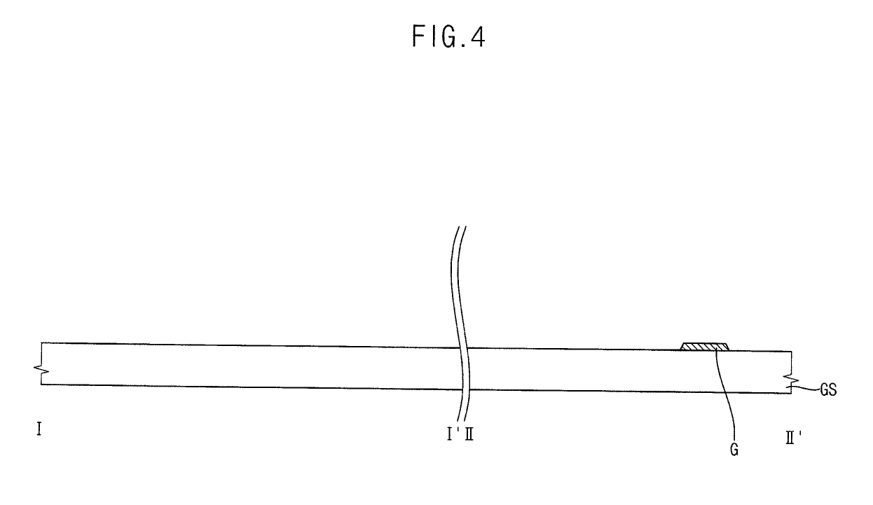

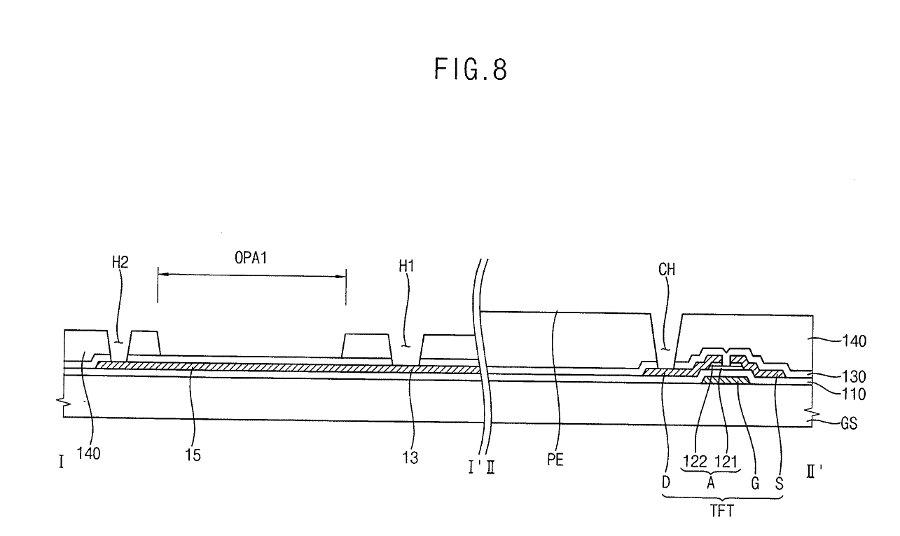

FIGS. 4 to 9 are cross-sectional views illustrating a method for manufacturing a display substrate 200 according to an exemplary embodiment of the present invention.

Referring to FIGS. 2 and 4, a first metal layer (not shown) is formed on the base substrate GS. For example, the first metal layer may include chromium, aluminum, tantalum, molybdenum, titanium, tungsten, copper, silver and so on, or an alloy thereof, and may include two or more layers having physical characteristics different from each other.

Then, the first metal layer (not shown) is patterned by a photolithography process using a first mask, to form the first metal pattern including the gate lines GL and the gate electrode G. For example, the photolithography process may include a wet etching process.

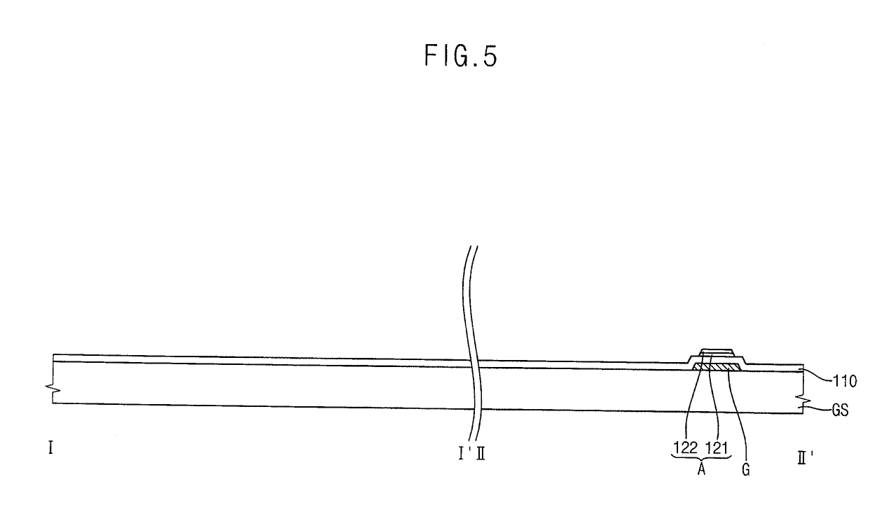

Referring to FIGS. 2 and 5, the gate insulating layer 110, the semiconductor layer 121 and the ohmic contact layer 122 are sequentially formed on the base substrate GS on which the first metal pattern is formed by a chemical vapor deposition (CVD) process. For example, the gate insulating layer 110 includes silicon nitride (SiNx) or silicon oxide (SiOx). The semiconductor layer 121 includes amorphous silicon. The ohmic contact layer 122 includes amorphous silicon doped with ions.

Then, the ohmic contact layer 122 and the semiconductor layer 121 are patterned at the same time by the photolithography process using a second mask, to form the channel layer A overlapping with the gate electrode G.

For example, the photolithography process for forming the channel layer A includes a dry etching process.

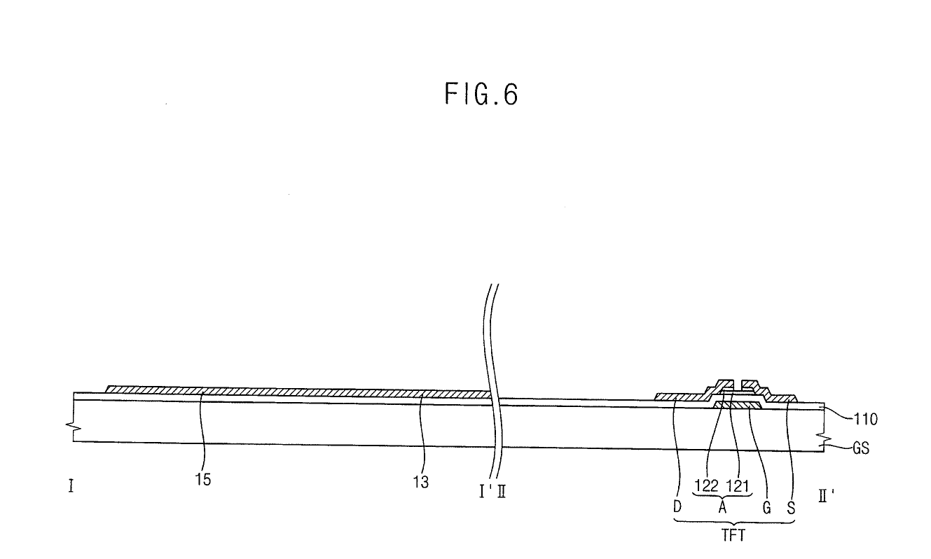

Referring to FIGS. 2 and 6, the second metal layer (not shown) is formed on the base substrate GS on which the channel layer A is formed. For example, the second metal layer may include chromium, aluminum, tantalum, molybdenum, titanium, tungsten, copper, silver and so on, or an alloy thereof, and may include two or more layers having physical characteristics different from each other.

Then, the second metal layer is patterned by the photolithography process using a third mask, to form the second metal pattern having data lines DL, the source electrode S, the drain electrode D, the metal pad layer 13 such as the FPC pad 12, and the connecting line 15. The connecting line 15 is directly connected to the metal pad layer 13.

In FIG. 6, the metal pad layer 13 is formed from the second metal pattern, and the first and second metal patterns are integrated to form the metal pad layer 13. When the first and second metal patterns are integrated to form the metal pad layer 13, a hole electrically connecting the first and second metal patterns is formed through the gate insulating layer 110 by an additional photolithography process.

Then, the ohmic contact layer 122 exposed at the separated portion between the source electrode S and the drain electrode D, is etched. For example, the ohmic contact layer 122 is etched using a dry etching process.

Accordingly, the thin-film transistor TFT including the gate electrode G, the channel layer A, the source electrode S and the drain electrode D is formed on the base substrate GS.

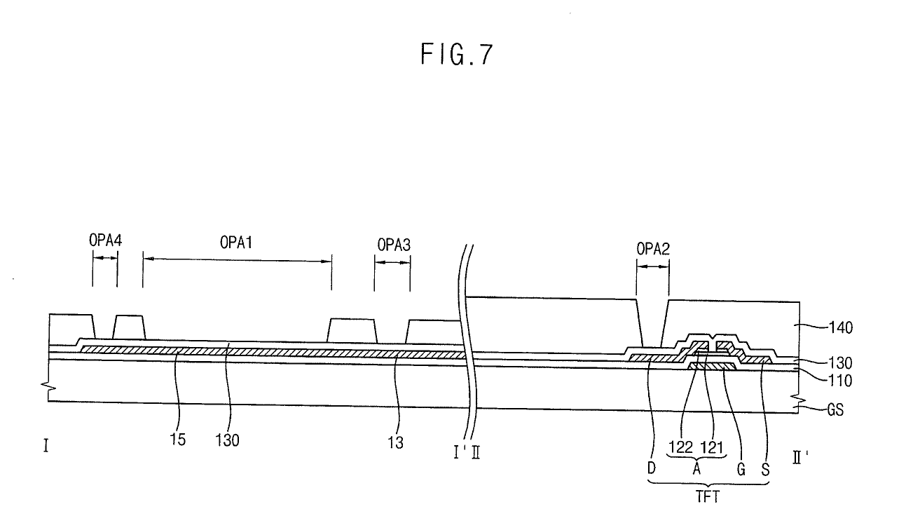

Referring to FIGS. 2 and 7, the passivation layer 130 is formed on the base substrate GS, on which the thin-film transistor TFT is formed, by the CVD process. For example, the passivation layer 130 may include silicon nitride (SiNx) or silicon oxide (SiOx).

Then, the organic insulating layer 140 including the organic material is formed on the passivation layer 130. For example, the organic insulating layer 140 includes a photosensitive organic material, and planarizes a surface of the base substrate GS on which the thin-film transistor TFT is formed.

Then, the organic insulating layer 140 is patterned by the photolithography process using a fourth mask. For example, when the organic insulating layer 140 is patterned by the photolithography process, the quantity of light irradiated onto the pixel area PA and the peripheral area CA is controlled, so that a thickness of the organic insulating layer 140 remaining after a developing process may be changed.

For example, the organic insulating layer 140 corresponding to the peripheral area CA is patterned to be relatively thin, so that elements such as the driving chip, the FPC and so on, which are used for driving and attached to the peripheral area CA, may be easily attached.

In addition, first, second, third and fourth opening patterns OPA1, OPA2, OPA3 and OPA4 are formed through the organic insulating layer 140 by the photolithography process. The first opening pattern OPA1 corresponds to a portion between a first portion of the organic insulating layer 140 on which the guard ring 20 is formed and a second portion of the organic insulating layer 140 on which the FPC pad 12 is formed. The second opening pattern OPA2 corresponds to an end portion of the drain electrode D. The third opening pattern OPA3 corresponds to the metal pad layer 13. The fourth opening pattern OPA4 corresponds to an area in which the connecting line 15 and the first portion on which the guard ring 20 is formed overlap with each other.

Referring to FIGS. 2, 7 and 8, the passivation layer 130 exposed through the first, second, third and fourth opening patterns OP1, OP2, OP3 and OP4 is etched by the dry etching process using the organic insulating layer 140 as an etching mask. Accordingly, the contact hole CH, the first hole H1 and the second hole H2 are formed through the organic insulating layer 140 and the passivation layer 130. The contact hole CH exposes the portion of the drain electrode D. The first hole H1 exposes the metal pad layer 13. The second hole H2 exposes the area in which the connecting line 15 and the first portion on which the guard ring 20 is formed overlap each other. In this case, the passivation layer 130 exposed through the first opening pattern OPA1 in FIG. 7 has an exposed area larger than any of the second, third and fourth opening patterns OPA2, OPA3 and OPA4. Thus, when the passivation layer 130 is etched, the passivation layer 130 exposed through the first opening pattern OPA1 is etched less than that exposed through the second, third and fourth opening patterns OPA2, OPA3 and OPA4. Thus, the passivation layer 130 corresponding to the first opening pattern OPA1 remains with a predetermined thickness after the dry etching process, to protect the connecting line 15.

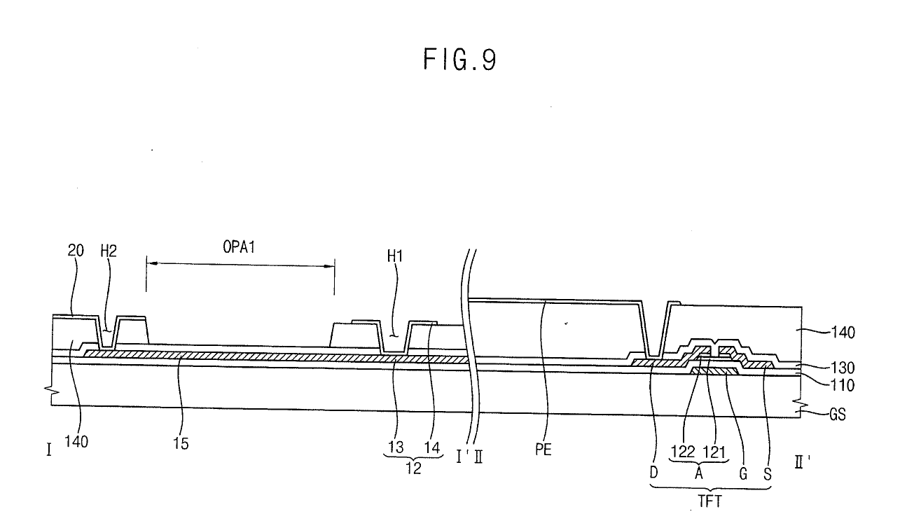

Referring to FIGS. 2 and 9, a transparent conductive layer (not shown) is deposited on the organic insulating layer 140. The contact hole CH, the first hole H1 and the second hole H2 are formed through the organic insulating layer 140. For example, the transparent conductive layer may include ITO, IZO, amorphous ITO and so on. The transparent conductive layer is deposited by a sputtering process.

Then, the transparent conductive layer is etched by the photolithography process using a fifth mask, to form the pixel electrode PE corresponding to the unit pixel P, the transparent pad layer 14 corresponding to the metal pad layer 13 and the guard ring 20 enclosing the active area 10.

The pixel electrode PE makes contact with the drain electrode D through the contact hole CH, and receives a pixel voltage from the thin-film transistor TFT. The transparent pad layer 14 is electrically connected to the metal pad layer 13 through the first hole H1, and the metal pad layer 13 and the transparent pad layer 14 form the FPC pad 12. The guard ring 20 is electrically connected to the connecting line 15 through the second hole H2.

Although not shown in the figure, the process for manufacturing the display substrate 200 further includes forming an alignment layer on the pixel area PA on which the pixel electrode PE is formed and forming textures on the alignment layer by the rubbing process.

According to exemplary embodiments of the present invention, the connecting line 15 is formed before forming the organic insulating layer 140, so that the frequency and/or severity of the patterning defects of the connecting line 15 occurring at the stepped portion such as the first opening pattern OPA1, may be reduced and/or prevented. Thus, the short circuits between FPC pads 12 due to the patterning defects of the connecting line 15 may be prevented, and the static electricity generated during the rubbing process may be efficiently dissipated.

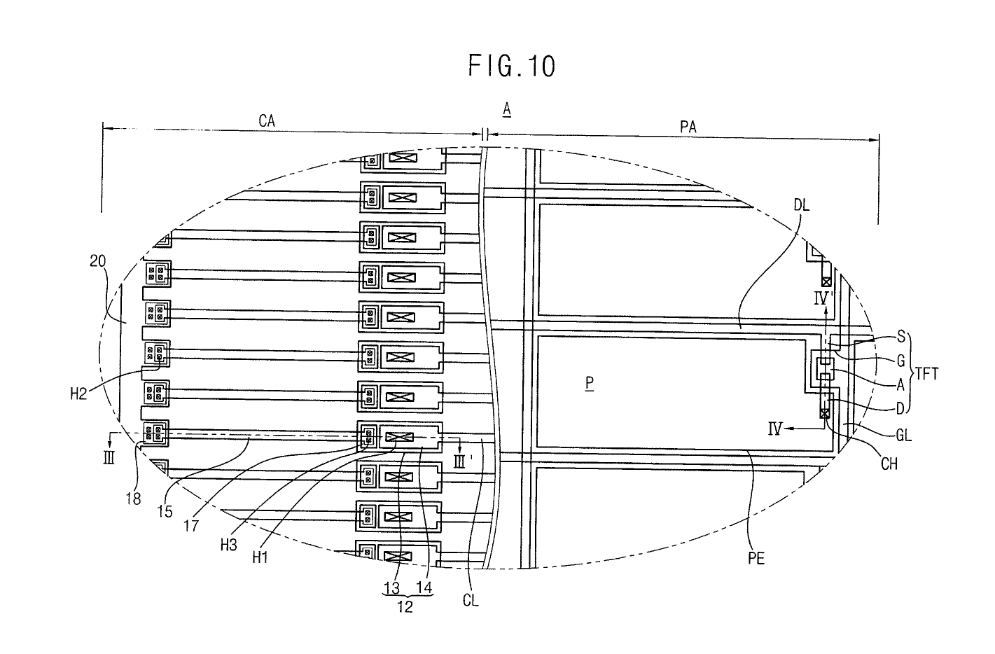

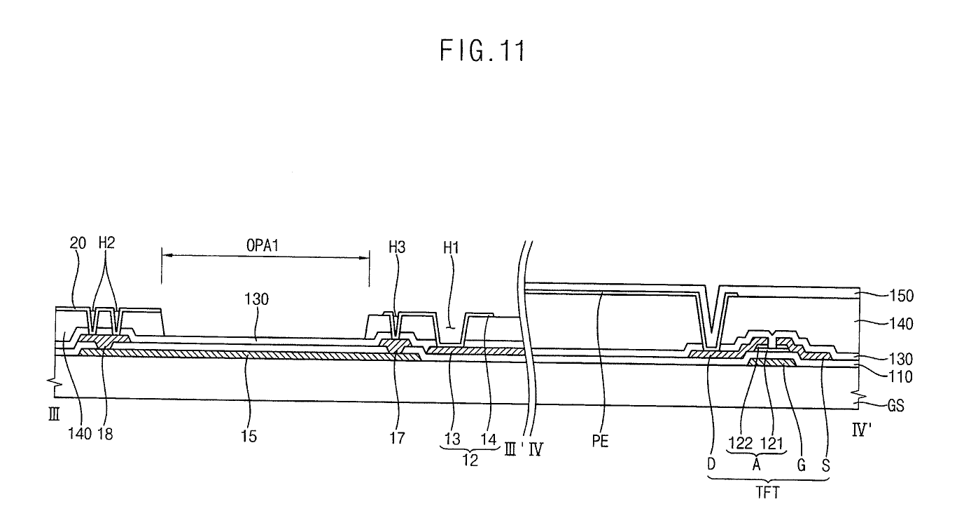

FIG. 10 is an enlarged plan view illustrating a portion “A” in FIG. 1 according to an exemplary embodiment of the display substrate 200. FIG. 11 is a cross-sectional view taken along lines III-III′ and IV-IV′ of FIG. 10. The display substrate according to the present exemplary embodiment is substantially the same as described above except with respect to, for example, a connection between the FPC pad 12 and the connecting line 15 formed in the peripheral area CA. Thus, the same reference numerals may refer to the same or like parts as those described in the previously mentioned exemplary embodiment.

Referring to FIGS. 10 and 11, the FPC pad 12 is connected to a circuit line CL formed in the peripheral area CA. The FPC pad 12 includes the metal pad layer 13 and the transparent pad layer 14. The metal pad layer 13 is formed from at least one of the first metal pattern forming the gate line GL and the second metal pattern forming the data line DL. The transparent pad layer 14 is electrically connected to the metal pad layer 13 and is formed from substantially the same layer as the pixel electrode PE.

In FIG. 11, the metal pad layer 13 is formed from the second metal pattern. For example, the metal pad layer 13 may be formed exclusively from the second metal pattern. Alternatively, the second metal pattern is integrated on the first metal pattern to form the metal pad layer 13. When the second metal pattern is integrated on the first metal pattern to form the metal pad layer 13, the hole is formed through the gate insulating layer 110 to electrically connect the first metal pattern with the second metal pattern.

The passivation layer 130 and the organic insulating layer 140 are formed between the metal pad layer 13 and the transparent pad layer 14. The first hole H1 partially exposing the metal pad layer 13 is formed through the passivation layer 130 and the organic insulating layer 140.

The transparent pad layer 14 is electrically connected to the metal pad layer 13 through the first hole H1. For example, the transparent pad layer 14 has a larger area than the metal pad layer 13.

The connecting line 15 is spaced apart from the metal pad layer 13 of the FPC pad 12 by a predetermined distance, and is formed from the first metal pattern as the gate line GL. In this case, first and second cover patterns 17 and 18 may be formed on the gate insulating layer 110 to correspond to both end portions of the connecting line 15. The first and second cover patterns 17 and 18 are formed from the second metal pattern, and make contact with the connecting line 15 through the holes (not shown) formed through the gate insulating layer 110.

In addition, the third hole H3 exposing the first cover pattern 17 and the second hole H2 exposing the second cover pattern 18 are formed through the passivation layer 130 and the organic insulating layer 140. One second hole H2 and one third hole H3 may be formed, respectively. Alternatively, a plurality of second holes H2 and a plurality of third holes H3 may be formed, respectively, as illustrated in FIG. 10.

The transparent pad layer 14 makes contact with the first cover pattern 17 through the third hole H3. The guard ring 20 makes contact with the second cover pattern 18 through the second hole H2.

Accordingly, the FPC pad 12, the connecting line 15 and the guard ring 20 are electrically connected with each other. Thus, when static electricity is generated during manufacturing the display substrate 200, the static electricity on a surface of the display substrate 200 may be dissipated over the entire surface of the base substrate GS through the transparent pad layer 14, the connecting line 15 and the guard ring 20.

According to the present exemplary embodiment, the connecting line 15 is formed before forming the organic insulating layer 140, and thus the frequency and/or severity of the patterning defects of the connecting line 15 formed in the stepped portion of the organic insulating layer 140 may be reduced or prevented. Thus, the short circuits between the FPC pads 12 due to the patterning defects of the connecting line 15 may be prevented, and the static electricity generated in manufacturing the display substrate may be efficiently dissipated. Accordingly, defects due to electrostatic discharge may be decreased.

In addition, the metal pad layer 13 of the FPC pad 12 is spaced apart from the connecting line 15, and the connecting line 15 is electrically connected to the FPC pad 12 through the transparent pad layer 14 having good corrosion resistance. Thus, even if a metal line formed on the base substrate GS is corroded, the metal line is spaced apart from the connecting line 15, so that the entire base substrate GS may be prevented from being corroded.

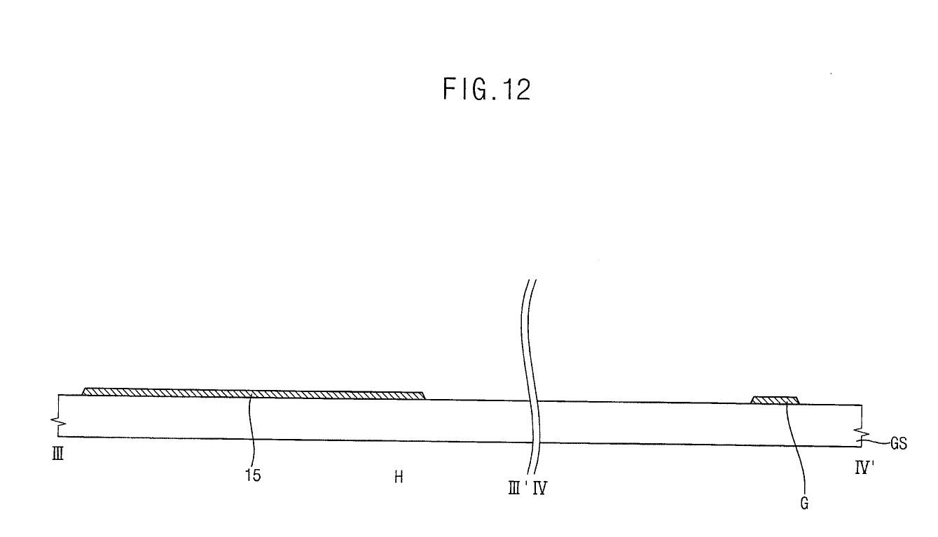

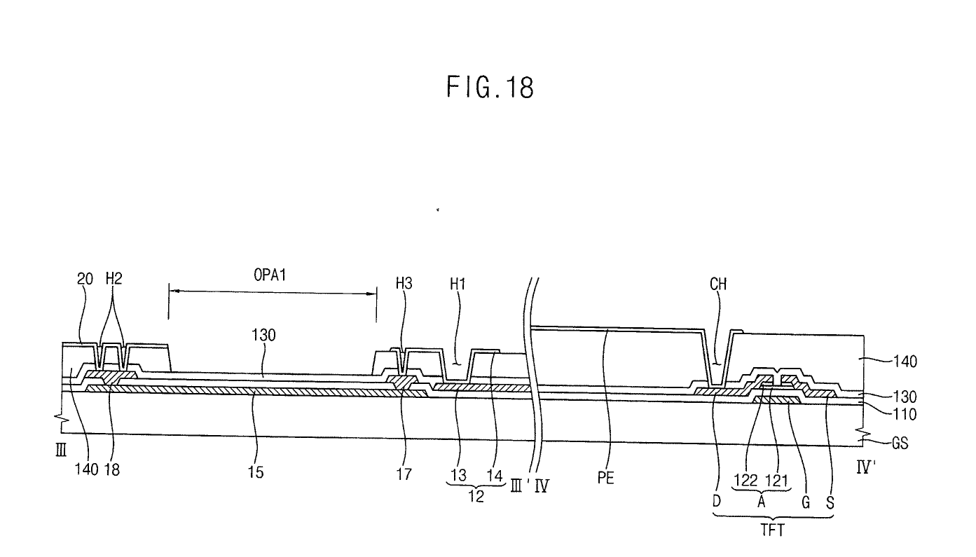

FIGS. 12 to 18 are cross-sectional views illustrating a method for manufacturing a display substrate 200 according to an exemplary embodiment of the present invention.

Referring to FIGS. 10 and 12, the first metal layer (not shown) is formed on the base substrate. For example, the first metal layer may include chromium, aluminum, tantalum, molybdenum, titanium, tungsten, copper, silver and so on, or an alloy thereof, and may include two or more layers having physical characteristics different from each other.

Then, the first metal layer (not shown) is patterned by a photolithography process using the first mask, to form the first metal pattern including the gate lines GL, the gate electrode G and the connecting line 15.

For example, the photolithography process may include the wet etching process.

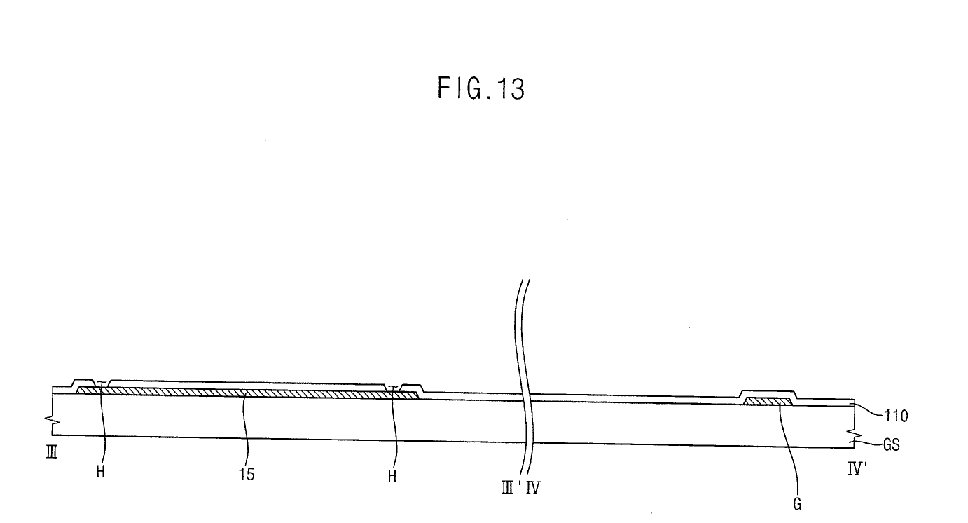

Referring to FIGS. 10 and 13, the gate insulating layer 110 is formed on the base substrate GS on which the first metal pattern is formed, by the CVD process.

Then, the gate insulating layer 110 is patterned by the photolithography process using the second mask, to form the holes H exposing both end portions of the connecting line 15.

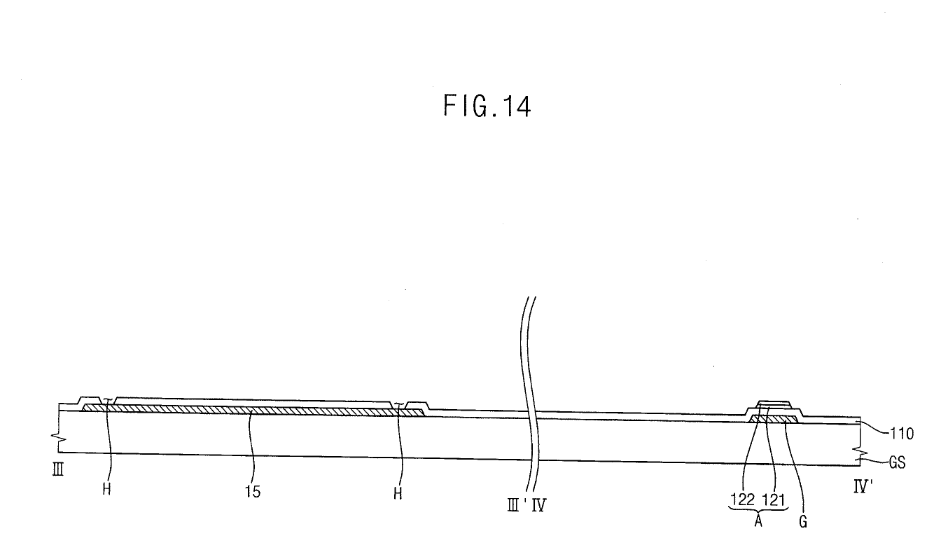

Referring to FIGS. 10 and 14, the semiconductor layer 121 and the ohmic contact layer 122 are sequentially formed on the gate insulating layer 110 through which the holes H are formed. For example, the semiconductor layer 121 includes amorphous silicon, and the ohmic contact layer 122 includes amorphous silicon doped with ions. The semiconductor layer 121 and the ohmic contact layer 122 may be formed by the CVD process.

Then, the ohmic contact layer 122 and the semiconductor layer 121 are patterned at the same time by the photolithography process using the third mask, to form the channel layer A overlapping the gate electrode G.

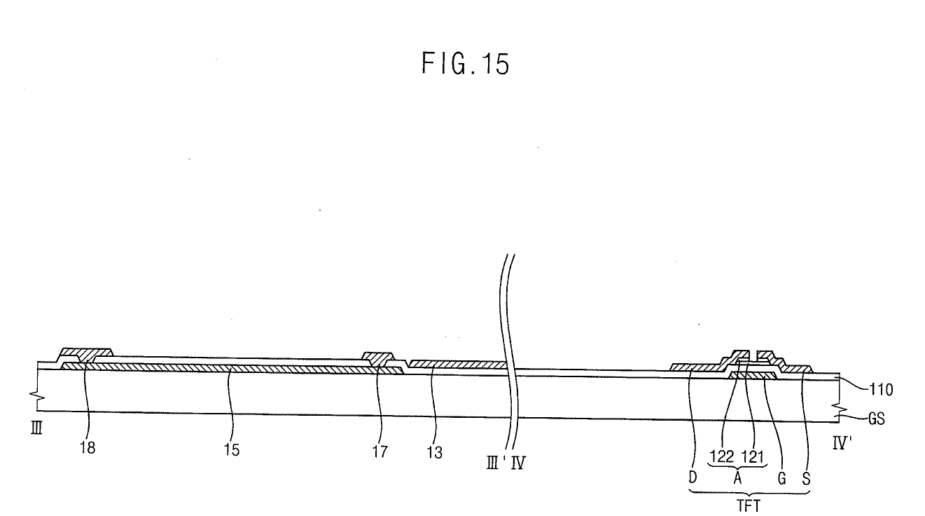

Referring to FIGS. 10 and 15, the second metal layer (not shown) is formed on the gate insulating layer 110 on which the channel layer A is formed. For example, the second metal layer may include chromium, aluminum, tantalum, molybdenum, titanium, tungsten, copper, silver and so on, or an alloy thereof, and may include two or more layers having physical characteristics different from each other.

Then, the second metal layer is patterned by the photolithography process using the fourth mask, to form the second metal pattern including the data lines DL, the source electrode S, the drain electrode D, the metal pad layer 13 of the FPC pad 12, the first cover pattern 17 and the second cover pattern 18. The metal pad layer 13 is spaced apart from the connecting line 15 by a predetermined distance.

FIG. 15 shows the metal pad layer 13 formed from the second metal pattern. Alternatively, the first and second metal patterns are integrated to form the metal pad layer 13. For example, when the first and second metal patterns are integrated to form the metal pad layer 13, the hole (not shown) electrically connecting the first and second metal patterns is further formed in the photolithography process using the third mask explained above in connection to FIG. 14.

Then, the ohmic contact layer 122 exposed at the separated portion between the source electrode S and the drain electrode D is etched. For example, the ohmic contact layer 122 may be etched by a dry etching process.

Accordingly, the thin-film transistor TFT including the gate electrode G, the channel layer A, the source electrode S and the drain electrode D is formed on the base substrate GS.

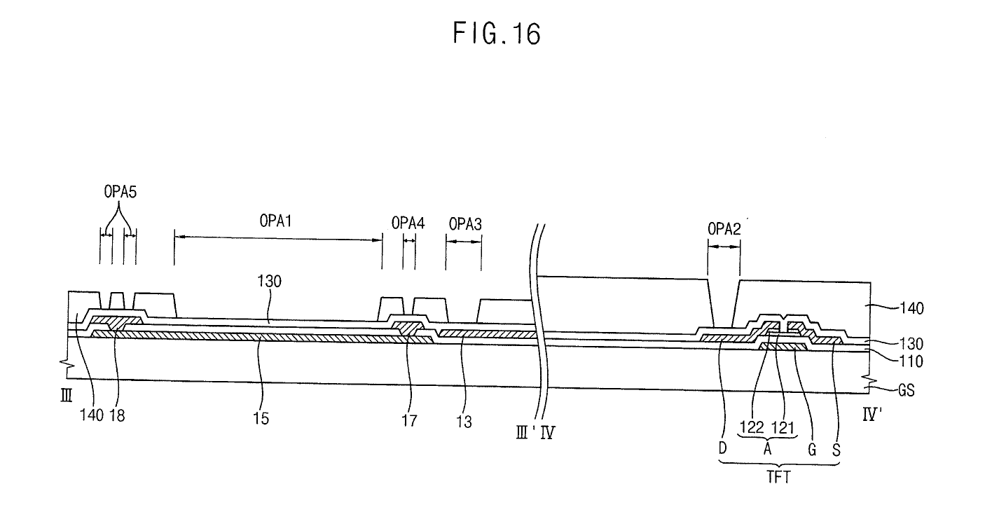

Referring to FIGS. 10 and 16, the passivation layer 130 is formed on the base substrate GS on which the thin-film transistor TFT is formed, by the CVD process. For example, the passivation layer 130 may include silicon nitride (SiNx) or silicon oxide (SiOx).

Then, the organic insulating layer 140 including the organic material is formed on the passivation layer 130. For example, the organic insulating layer 140 includes the photosensitive organic material. The organic insulating layer 140 planarizes the surface of the base substrate GS on which the thin-film transistor TFT is formed.

Then, the organic insulating layer 140 is patterned by the photolithography process using the fifth mask. For example, when the organic insulating layer 140 is patterned by the photolithography process, the quantity of the light irradiated to the pixel area PA and the peripheral area CA is controlled, so that the thickness of the organic insulating layer 140 remaining after the developing process may be changed.

For example, since the elements such as the driving chip, the FPCB and so on used for driving are attached to the peripheral area CA, the organic insulating layer 140 corresponding to the peripheral area CA is preferably patterned to be relatively thin, so that the elements may be easily attached. In addition, first, second, third, fourth and fifth opening patterns OPA1, OPA2, OPA3, OPA4 and OPA5 are formed through the organic insulating layer 140 by the photolithography process. The first opening pattern OPA1 corresponds to the portion between the first portion on which the guard ring 20 is formed and the second portion on which the FPC pad 12 is formed. The second opening pattern OPA2 corresponds to the end portion of the drain electrode D. The third opening pattern OPA3 corresponds to the metal pad layer 13. The fourth opening pattern OPA4 corresponds to the first cover pattern 17 of the connecting line 15. The fifth opening pattern OPA5 corresponds to the second cover pattern 18 of the connecting line 15.

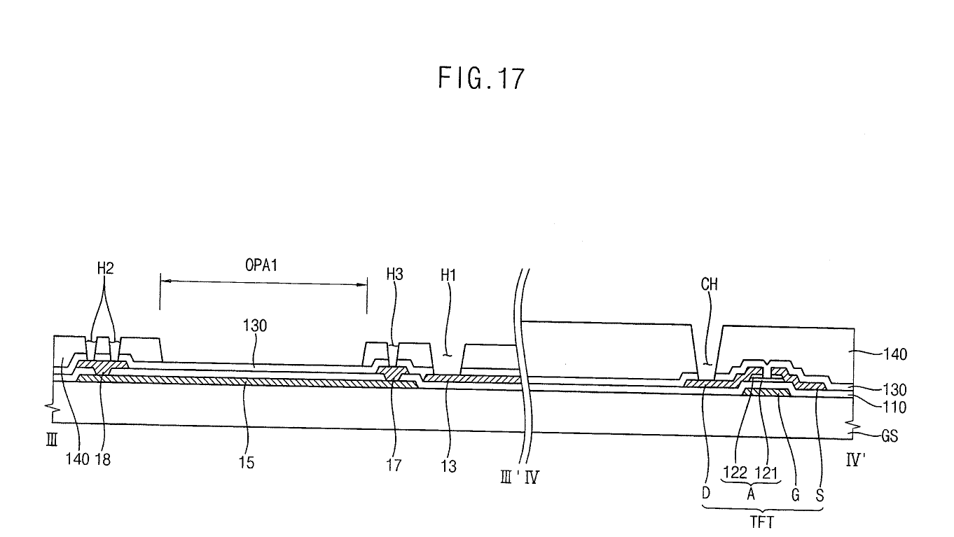

Referring to FIGS. 10 and 17, the passivation layer 130 is etched by the dry etching process using the organic insulating layer 140 as an etching mask, to form the contact hole CH exposing the portion of the drain electrode D, the first hole H1 exposing the metal pad layer 13, the second hole H2 exposing the second cover pattern 18 of the connecting line 15, and the third hole H3 exposing the first cover pattern 17.

Referring to FIGS. 1, 10 and 18, the transparent conductive layer (not shown) is deposited on the organic insulating layer 140 through which the contact hole CH, the first hole H1, the second hole H2 and the third hole H3 are formed. For example, the transparent conductive layer may include ITO, IZO, amorphous ITO and so on. The transparent conductive layer is deposited by the sputtering process.

Then, the transparent conductive layer is etched by the photolithography process using a sixth mask, to form the pixel electrode PE corresponding to the unit pixel P, the transparent pad layer 14 corresponding to the metal pad layer 13 and the guard ring 20 enclosing the active area 10.

The pixel electrode PE makes contact with the drain electrode D through the contact hole CH, and receives the pixel voltage from the thin-film transistor TFT.

The transparent pad layer 14 is electrically connected to the metal pad layer 13 through the first hole H1, the metal pad layer 13 and the transparent pad layer 14 forms the FPC pad 12. In this case, the metal pad layer makes contact with the first cover pattern 17 through the third hole H3. Since the first cover pattern 17 makes contact with the connecting line 15, the FPC pad 12 and the connecting line 15 are electrically connected with each other.

The guard ring 20 makes contact with the second cover pattern 18 through the second hole H2. Since the second cover pattern 17 makes contact with the connecting line 15, the guard ring 20 is electrically connected to the connecting line 15. Thus, the FPC pad 12, the connecting line 15 and the guard ring 20 are electrically connected with each other, so that the active area 10 may be protected and the static electricity may be dissipated to the entire base substrate GS when the static electricity is generated in manufacturing the display substrate 200.

Although not shown in the figure, the process for manufacturing the display substrate 200 further includes forming the alignment layer on the pixel area PA on which the pixel electrode PE is formed and forming textures on the alignment layer by the rubbing process. Manufacturing of the display substrate 200 is complete after the rubbing process.

According to an exemplary embodiment of the present invention, the connecting line 15 is formed before forming the organic insulating layer 140, so that the frequency and/or severity of reduced or patterning defects of the connecting line 15 occurring at the stepped portion in the organic insulating layer 140, may be prevented. Thus, the short circuits between FPC pads 12 due to the patterning defects of the connecting line 15 may be reduced or prevented, and the static electricity generated during the rubbing process may be efficiently dissipated. Accordingly, the frequency and/or severity of defects of the display substrate 200 due to electrostatic discharge may be reduced or prevented.

In addition, the metal pad layer 13 of the FPC pad 12 is spaced apart from the connecting line 15, so that the connecting line 15 is electrically connected to the FPC pad 12 through the transparent pad layer 14 having good corrosion resistance. Thus, even if the metal line formed on the base substrate GS is corroded, the metal line is spaced apart from the connecting line 15, so that the entire base substrate GS may be prevented from being corroded.

After completely manufacturing the display substrate 200, the display substrate 200 may be cut to manufacture the display apparatus using the active area 10 as the array substrate.

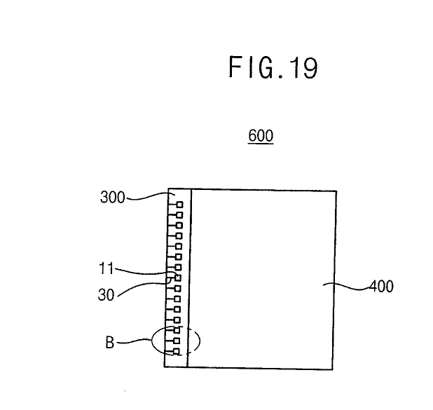

FIG. 19 is a plan view illustrating a display apparatus 600 according to an exemplary embodiment of the present invention.

Referring to FIGS. 1 and 19, for example, the display apparatus 600 according to the present exemplary embodiment may be an LCD apparatus 600. The LCD apparatus 600 includes a first substrate 300, a second substrate 400 and a liquid crystal layer (not shown) interposed between the first and second substrates 300 and 400. In this case, the LCD apparatus 600 uses the array area 10 of the display substrate 200 as described above with reference to FIG. 1 as the first substrate 300.

For example, the first substrate 300 is cut along the array area 10 of the display substrate 200 as seen in FIG. 1. The first substrate 300 is the array substrate on which the thin-film transistor TFT and the signal lines are formed.

The elements included in the first substrate 300 are described with reference to the array area 10 in FIGS. 1 to 3.

The second substrate 400 corresponds to the pixel area PA of the first substrate 300 and, for example, may be a color filter substrate on which color filters corresponding to the unit pixels are formed.

The second substrate 400 is attached to the display substrate 200, to correspond to the pixel area PA of the display substrate 200 described above with reference to FIGS. 1 to 3, and the liquid crystal layer (not shown) is injected between the display substrate 200 and the second substrate 400. Then, the display substrate 200 is cut along the active area 10. Thus, the LCD apparatus 600 may be manufactured.

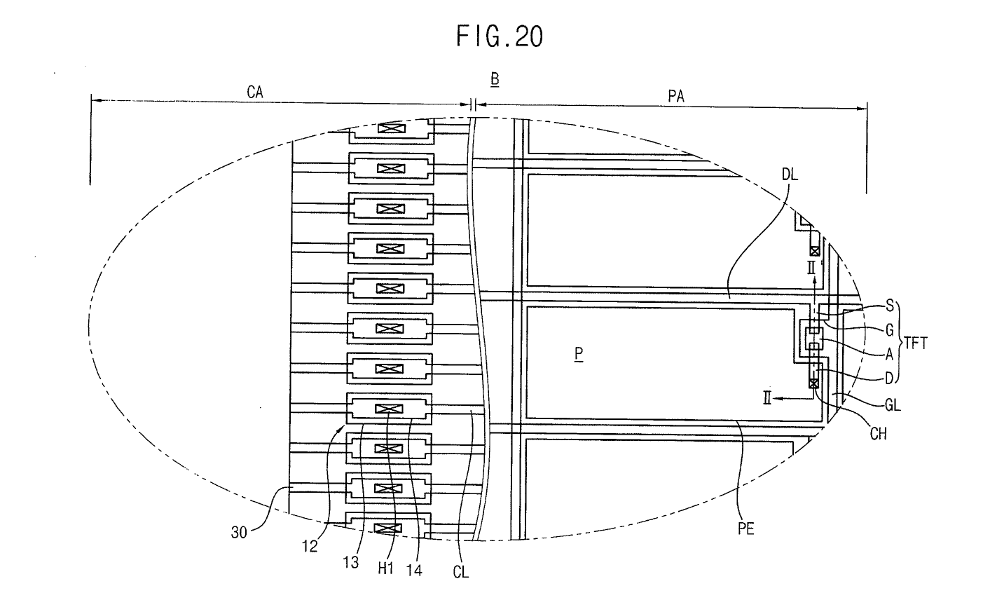

FIG. 20 is an enlarged plan view illustrating a portion “B” in FIG. 19.

Referring to FIGS. 1, 2 and 20, the connecting line 15 formed on the display substrate 200, is cut by the scribing process cutting the display substrate 200 along the active area 10, so that a connecting line remaining portion 30 that is a portion of the connecting line 15 remains on the first substrate 300 of the display apparatus 600.

For example, the connecting line remaining portion 30 is respectively connected to the pads 11, for example the FPC pad 12, and extends to the edge of the first substrate 300. Thus, the connecting line remaining portion 30 having a cut shape, remains at the edge of the first substrate 300.

The connecting line remaining portion 30 is formed from substantially the same layer and substantially the same process as the connecting line 15 that is described above.

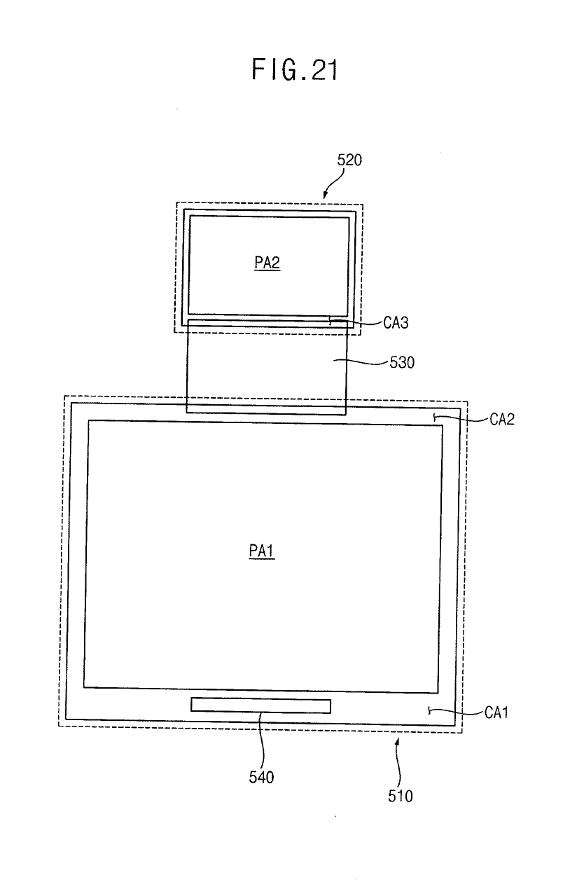

FIG. 21 is a plan view illustrating a display apparatus according to an exemplary embodiment of the present invention.

Referring to FIG. 21, the display apparatus according to the present exemplary embodiment includes a first display panel 510 on which a driving chip 540 is mounted, an FPCB 530 and a second display panel 520.

The first display panel 510 displays a first image through a first display area PA1 in which a plurality of unit pixels (not shown) are formed. A plurality of lines (not shown), a plurality of thin-film transistors (not shown), each of which switches a corresponding unit pixel, and a plurality of unit electrodes (not shown), each of which is electrically connected to a corresponding TFT, are formed in the first display area PA1. The driving chip 540 is mounted in a first peripheral area CA1 surrounding the first display area PA1 of the first display panel 510, and the FPCB 530 is attached to a second peripheral area CA2.

The driving chip 540 is electrically connected to the lines of the first display panel 510, and transmit a driving signal to the first display area PA1. A visual pad portion (not shown) that is electrically connected to the lines and is used for visual inspection, may be formed in the first peripheral area CA in which the driving chip 540 is mounted.

The FPCB 530 is attached to the second peripheral area CA2 of the first display panel 510. For example, the FPCB 530 may be connected to the second peripheral area CA2, by pressing an anisotropic conductive film (not shown) interposed between the second peripheral area CA2 of the first display panel 510 and the FPCB 530 at a high temperature. The FPCB 530 is attached to a third peripheral area CA3 surrounding a second display area PA2 of a second display panel 520, to electrically and physically connect the first display panel 510 with the second display panel 520.

The second display panel 520 displays a second image through the second display area PA2 in which the plurality of unit pixels (not shown) are formed. The plurality of lines (not shown), the plurality of TFTs (not shown), each of which switches a corresponding unit pixel, and a plurality of unit electrodes (not shown), each of which is electrically connected to a corresponding TFT, are formed in the second display area PA2. The driving signal from the driving chip 540 mounted on the first display panel 510 is transmitted to the second display panel 520 through the FPCB 530 connected to a third peripheral area CA3 surrounding the second display panel 520. The second display panel 520 is driven by the driving signal transmitted to the second display panel 520 through the FPCB 530.

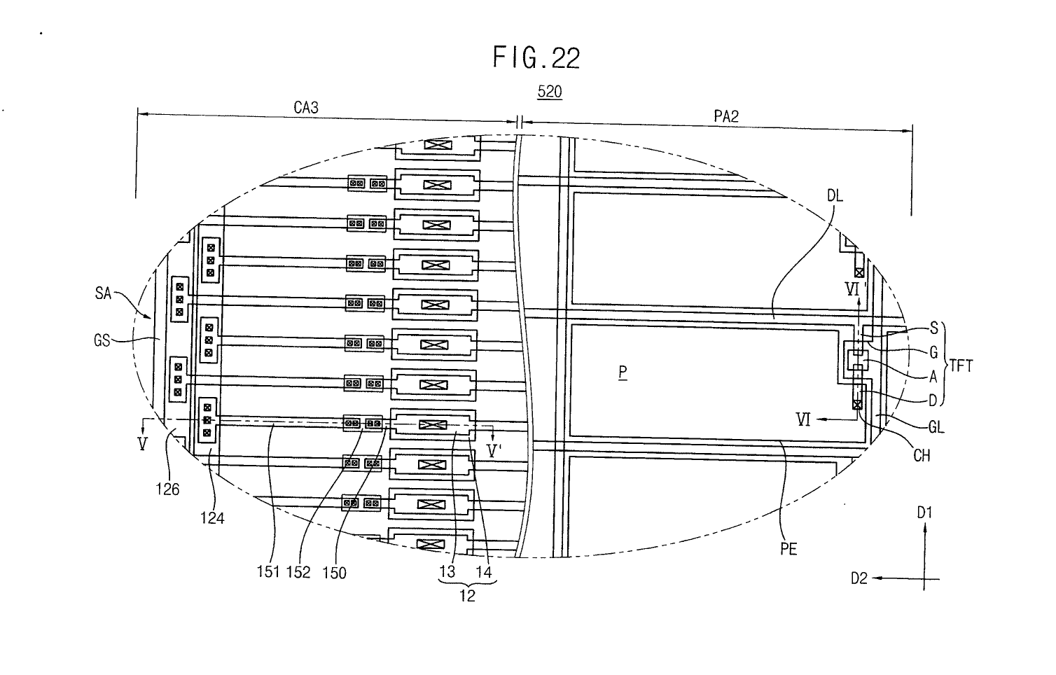

FIG. 22 is an enlarged plan view illustrating a second display panel of the display apparatus shown in FIG. 21 according to an exemplary embodiment of the present invention.

Referring to FIG. 22, gate lines GL, data lines DL, TFTs and pixel electrodes PE are formed in the second display area PA2 of the second display panel 520 according to the present exemplary embodiment. A FPC pad 12, a first connecting line 150, a second connecting line 151, a bridge 152 and a shorting bar 124 and 126 are formed in the third peripheral area CA3 of the second display panel 520 according to the present exemplary embodiment.

The second display panel according to the present exemplary embodiment is substantially the same as described above except with respect to, for example, the first and second connecting lines 150 and 151. Thus, the same reference numerals may refer to the same or like parts as those described above.

Each FPC pad 12 is formed at an end portion of each of data lines DL extending from the second display area PA2 to the third peripheral area CA3. The FPC pad 12 includes a metal pad layer 13 electrically connected to the data line DL and a first transparent pad layer 14 making contact with the metal pad layer 13.

The first connecting line 150 is formed in the third peripheral area CA3 and is electrically connected to the metal pad layer 13. For example, the first connecting line 150 extends from the FPC pad 12 to an outer area SA of the base substrate GS. The second connecting line 151 is spaced apart from the first connecting line 150 and is formed in the third peripheral area CA3. The first and second connecting lines 150 and 151 are spaced apart from each other and are physically separated. The first and second connecting lines 150 and 151 are electrically connected with each other via the bridge 152.

The bridge 152 is formed in the third peripheral area CA3 to electrically connect the first connecting line 150 with the second connecting line 151. A first end portion of the bridge 152 makes contact with the first connecting line 150, and a second end portion of the bridge 152 makes contact with the second connecting line 151, so that the bridge 152 electrically connects the first connecting line 150 with the second connecting line 151.

The shorting bar 124 and 126 is formed in the third peripheral area CA3 to make contact with the second connecting lines 151. The shorting bar 124 and 126 is connected to a visual pad (not shown) that applies an inspection signal for the visual inspection. The shorting bar 124 and 126 extends along a first direction D1, and includes a first inspection line 124 and a second inspection line 126 that are disposed parallel to each other along a second direction D2 substantially perpendicular to the first direction D1.

For example, the first inspection line 124 may be connected to a k-th data line DLk, and the second inspection line 126 may be connected to a (k+1)-th data line DL(k+1) adjacent to the k-th data line DLk along the first direction D1. The first inspection line may be connected to a (k+2)-th data line DL(k+2) adjacent to the (k+1)-th data line DL(k+1) along the first direction D1. For example, the k-th and (k+2)-th data lines DLk and DL(k+2) may be odd-numbered data lines and the (k+1)-th data line DL(k+1) may be even-numbered data lines. For example, each of the first and second inspection lines 124 and 126 may have a bar shape along the outer area SA of the base substrate, respectively. The shorting bar 124 and 126 may be electrically connected to an inspection pad (not shown) that applies the inspection signal.

The shorting bar 124 and 126 makes contact with the second connecting lines 151 to electrically connect the plurality of data lines DL with each other. The shorting bar 124 and 126 is electrically connected to the visual pad that applies the inspecting signal to transmit the inspecting signal to the data lines DL. After the visual inspection, the second connecting lines 151 are cut, and thus the second connecting lines 124 and the shorting bar 124 and 126 are electrically separated. For example, the second connecting lines 151 may be electrically separated from the data lines DL by a laser trimming process.

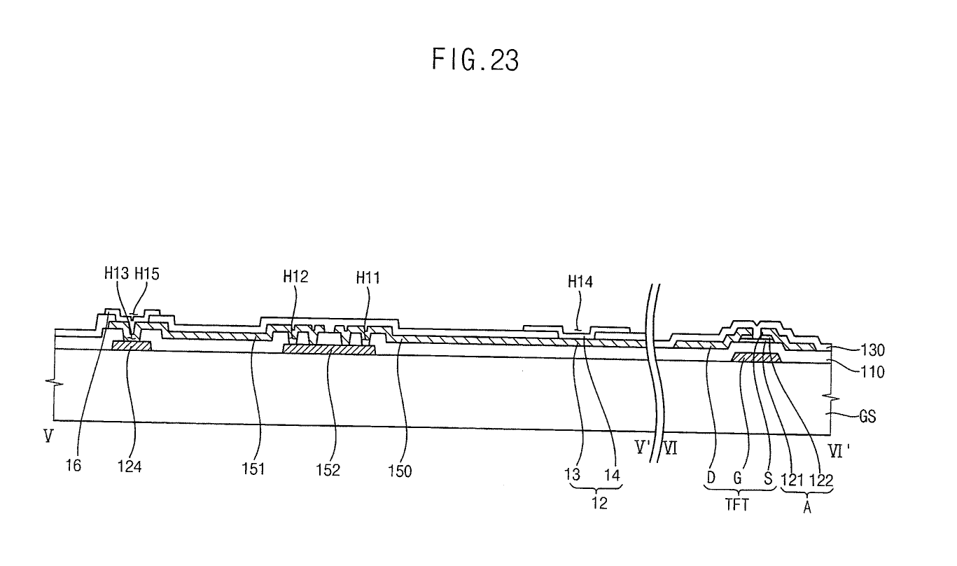

FIG. 23 is a cross-sectional view taken along lines V-V′ and VI-VI′ of FIG. 22.

Referring to FIGS. 22 and 23, the gate electrode G of the TFT, the bridge 152 and the first inspecting line 124 that are electrically connected to the gate line GL, are formed on the base substrate GS of the second display panel 520 according to the present exemplary embodiment. The first inspection line 124 will be explained as an example of the shorting bar 124 and 126.

The base substrate GS may include a transparent material. For example, the base substrate GS may be a glass substrate, a plastic substrate, a soda-lime substrate and so on.

The gate electrode G, the bridge 152 and the first inspecting line 124 are formed by patterning the gate metal layer formed on the base substrate GS.

The gate insulating layer 110 is formed on the base substrate GS on which the gate electrode G, the bridge 152 and the first inspection line 124 are formed. For example, the gate insulating layer 110 may include silicon nitride (SiNx). The gate insulating layer 110 includes an eleventh hole H11 and a twelfth hole H12 partially exposing the bridge 152, and a thirteenth hole H13 partially exposing the first inspection line 124.

The channel layer A is formed on the base substrate GS on which the gate insulating layer 110 is formed.

The source and drain electrodes S and D of the TFT, the metal pad layer 13 electrically connected to the data line DL, and the first and second connecting lines 150 and 151, are formed on the base substrate GS on which the channel layer A is formed. The source and drain electrodes S and D, the metal pad layer 13, and the first and second connecting lines 150 and 151 are formed by patterning the source metal layer by a photo etching process.

The source and drain electrodes S and D are formed on the channel layer A under which the gate electrode G is formed, so that the source and drain electrodes S and D partially overlap with the gate electrode G. The source and drain electrodes S and D are spaced apart from each other. The metal pad layer 13 is electrically connected to the data line DL.

The first connecting line 150 is electrically connected to the metal pad layer 13. The first connecting line 150 makes contact with the bridge 152 through the eleventh hole H11 of the gate insulating layer 110. The second connecting line 151 is spaced apart from the first connecting line 150, and the second connecting line 151 makes contact with the bridge 152 via the twelfth hole H12 of the gate insulating layer 110. The first and second connecting lines 150 and 151 are electrically connected with each other via the bridge 152. The second connecting line 151 makes contact with the first inspection line 124 through the thirteenth hole 13 H13 of the gate insulating layer 110.

The passivation layer 130 is formed on the base substrate GS on which the source electrode S, the drain electrode D, the metal pad layer 13 and the first and second connecting lines 150 and 151 are formed. The passivation layer 130 includes a contact hole CH partially exposing the drain electrode D, a fourteenth hole H14 partially exposing the metal pad layer 13, and a fifteenth hole H15 partially exposing the second connecting line 151 that makes contact with the first inspection line 124. The passivation layer 130 covers the source and drain electrodes S and D, and covers the first and second connecting lines 150 and 151. For example, the passivation layer 130 may include silicon nitride (SiNx).

Although not shown in the figure, an organic layer (not shown) that is relatively thick may be formed on the passivation layer 130. When the second display panel 520 includes the organic layer, the organic layer may further include holes corresponding to the contact hole CH and the fifteenth hole H15 of the passivation layer 130.

The pixel electrode PE, a first transparent pad layer 14 and a second transparent pad layer 16 of the FPC pad 12 are formed on the base substrate GS on which the passivation layer 130 is formed. The pixel electrode PE is formed on the unit pixel P, and makes contact with an end portion of the drain electrode D through the contact hole CH of the passivation layer 130. The first transparent pad layer 14 makes contact with the metal pad layer 13 through the fourteenth hole H14. The second transparent pad layer 16 makes contact with an end portion of the second connecting line 151 through the fifteenth hole H15. The pixel electrode PE, and the first and second transparent pad layers 14 and 16 may be formed by patterning the transparent conductive layer that includes a transparent material and a conductive material. For example, the transparent conductive layer may include indium tin oxide (ITO), indium zinc oxide (IZO) and so on.

According to the present exemplary embodiment of the present invention, the first connecting line 150 is spaced apart from the second connecting line 151, and the first and second connecting lines 150 and 151 are electrically connected with each other via the bridge 152, so that corrosion of the data line DL may be minimized. For example, when the second connecting line 151 that is trimmed by the laser trimming process is exposed to moisture, the moisture permeates into the second connecting line 151, the bridge 152 and the first connecting line 150 sequentially, so that it takes a relatively long time for the moisture to reach the metal pad layer 13. Thus, corrosion of the metal pad layer 13 and the data line DL may be minimized.

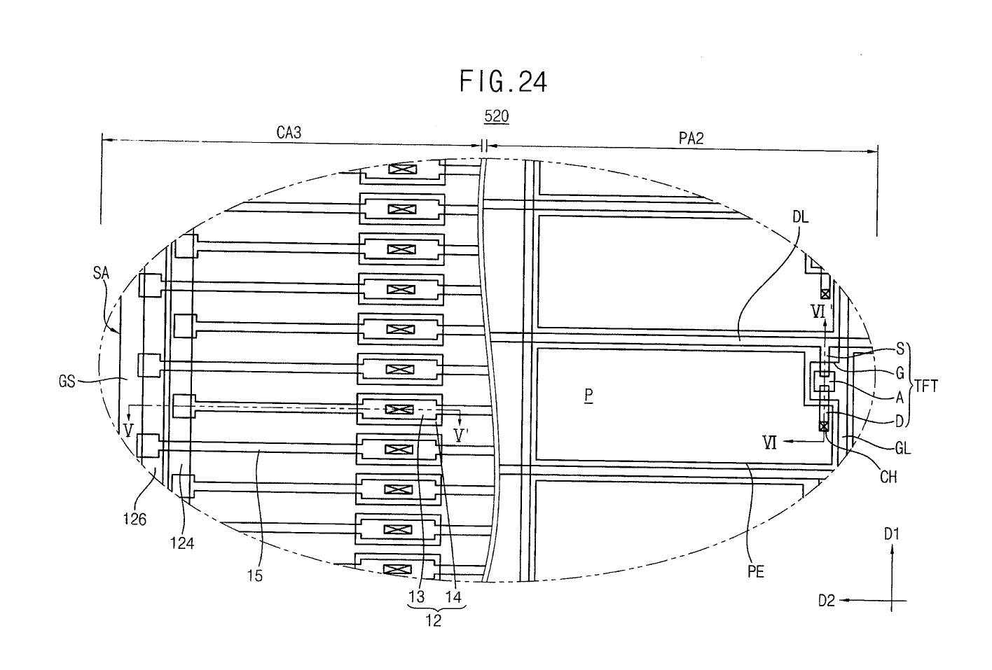

FIG. 24 is an enlarged plan view illustrating a second display panel of the display apparatus shown in FIG. 21 according to an exemplary embodiment of the present invention.

The second display panel 520 according to the present exemplary embodiment is substantially the same as discussed above with respect to FIG. 22 except for the FPC pad 12, the connecting lines 15 and the shorting bar 124 and 126. Thus, the same reference numerals may refer to the same or like parts as those described above.

Referring to FIG. 24, the gate lines GL, the data lines DL, the thin-film transistors and the pixel electrodes PE are formed in the second display area PA2 of the second display panel 520 according to the present exemplary embodiment, and the FPC pad 12, the connecting lines 15 and the shorting bar 124 and 126 are formed in the third peripheral area CA3 of the second display panel 520 according to the present exemplary embodiment.

Each FPC pad 12 is formed at the end portion of each of the data lines DL extending from the second display area PA2 to the third peripheral area CA3. The FPC pad 12 includes the metal pad layer 13 electrically connected to the data line DL, and the first transparent pad layer 14 making contact with the metal pad layer 13.

Each connecting line 15 is formed in the third peripheral area CA3 and is electrically connected to the first transparent pad layer 14. For example, the connecting line 15 extends from the FPC pad 12 to the outer area SA of the base substrate GS.

The shorting bar 124 and 126 is formed in the third peripheral area CA3 and makes contact with the connecting lines 15. The shorting bar 124 and 126 may include the first and second connecting lines 124 and 126 that extend along the first direction D1 and are disposed sequentially and parallel to each other along the second direction D2. For example, the first inspection line 124 may be electrically connected to the odd-numbered data lines DL, and the second inspection line 126 may be disposed parallel to the first inspection line 124 and may be electrically connected to the even-numbered data lines DL. The shorting bar 124 and 126 may be formed along the outer area SA of the base substrate GS with the bar shape.

A distance between the FPC pad 12 and the shorting bar 124 and 126 according to the present example embodiment is formed shorter than the distance between the FPC and the shorting bar discussed above, so that the resistance of the connecting line 15 may be decreased.

The shorting bar 124 and 126 makes contact with the connecting lines 15, to electrically connect the plurality of data lines DL with each other. The shorting bar 124 and 126 transmits the inspection signal for the visual inspection to the data lines DL. After the visual inspection, the connecting lines 15 are cut, so that the shorting bar 124 and 126 is electrically separated from the connecting lines 15. For example, the connecting lines 15 may be electrically separated from the data lines DL by the laser trimming process.

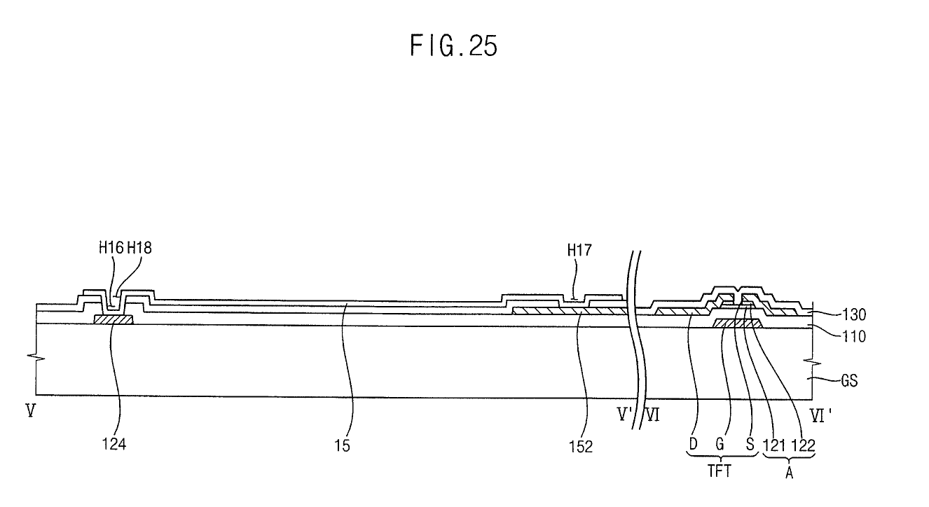

FIG. 25 is a cross-sectional view taken along lines V-V′ and VI-VI′ of FIG. 24.

The second display panel 520 according to the present exemplary embodiment is substantially the same as discussed above with respect to FIG. 23 except with respect to, for example, the FPC pad 12, the connecting lines 15 and the shorting bar 124 and 126. Thus, the same reference numerals may refer to the same or like parts as those described above.

Referring to FIGS. 24 and 25, the gate electrode of the thin-film transistor TFT electrically connected to the gate line GL and the first inspection line 124 may be formed on the base substrate of the second display panel 520 according to the present exemplary embodiment. The gate electrode G and the first inspection line 124 are formed from the gate metal layer.

The gate insulating layer 110 is formed on the base substrate GS on which the gate electrode G and the first inspection line 124 are formed. The gate insulating layer 110 includes a sixteenth hole H16 partially exposing the first inspection line 124.

The source and drain electrodes S and D of the thin-film transistor TFT, and the metal pad layer 13 connected to the end portion of the data line DL are formed on the base substrate GS on which the gate insulating layer 110 is formed. The source electrode S, the drain electrode D and the metal pad layer 13 are formed from the source metal layer.

The passivation layer 130 is formed on the base substrate GS on which the source electrode S, the drain electrode D and the metal pad layer 13 are formed. The passivation layer 130 includes the contact hole CH exposing the end portion of the drain electrode D, a seventeenth hole H17 partially exposing the metal pad layer 13 and an eighteenth hole H18 partially exposing the first inspection line 124 corresponding to the sixteenth hole H16 of the gate insulating layer.

Although not shown in the figure, the organic layer (not shown) being relatively thick may be formed on the passivation layer 130. When the second display panel 520 includes the organic layer, the organic layer may further include holes corresponding to the contact hole CH and the seventeenth hole H17 of the passivation layer 130.

The pixel electrode PE, the first transparent pad layer 14 and the connecting line 15 are formed on the base substrate GS on which the passivation layer 130 is formed. The pixel electrode PE makes contact with the drain electrode D through the contact hole CH, and the first transparent pad layer 14 makes contact with the metal pad layer 13 through the seventeenth hole H17. The connecting line 15 is connected to the first transparent pad layer 14, and an end portion of the connecting line 15 makes contact with the first inspection line 124 that is exposed through the sixteenth hole H16 of the gate insulating layer 110 and the eighteenth hole H18 of the passivation layer 130.

According to the present exemplary embodiment, the connecting line 15 connected to the first transparent pad layer 14 of the FPC pad 12 is connected to the first inspection line 124, so that the frequency and/or severity of corrosion of the data line DL may be minimized. For example, the connecting line 15 is formed by patterning the transparent conductive layer that includes ITO, IZO or another such material having good corrosion resistance, so that when the connecting line 15 is trimmed by the laser trimming process, the frequency and/or severity of corrosion of the connecting line 15 and the first transparent pad layer 14 due to the moisture may be reduced or prevented. Thus, the frequency and/or severity of corrosion of the metal pad layer 13 and the data line DL may be minimized.

According to an exemplary embodiment of the present invention, a connecting line electrically connecting a guard ring with a pad is formed before forming an organic insulating layer, so that the frequency and/or severity of patterning defects of the connecting line occurring at a stepped portion of the organic insulating layer may be reduced or prevented. Accordingly, short circuits that are caused by a conductive layer remaining on the stepped portion of the organic insulating layer, may be prevented and static electricity may be efficiently dissipated.

According to an exemplary embodiment of the present invention, the connecting line is spaced apart from a first pad layer, and the connecting line is electrically connected to a second pad layer through the second pad layer including material having high corrosion resistance such as ITO. Thus, even if a metal line is corroded along the connecting line, the connecting line is spaced apart from the first pad layer, so that entire pads may be prevented from being corroded.

In addition, the connecting line that electrically connects the guard ring and the pad is formed before forming the organic insulating layer, so that a short circuit between the pads may be prevented. Thus, an electric charge may be efficiently dissipated.

In addition, the connecting line is spaced apart from the first pad layer and the connecting line is electrically connected to the second pad layer through the second pad layer, having good corrosion resistance and including ITO. Thus, when the corrosion proceeds along the connecting line, the pads may be prevented from being corroded.

In addition, the connection of a shorting bar and an FPC pad of a second display panel in a first module driving the second display panel using a driving chip of a first display panel, is changed, so that corrosion of a data line may be minimized. Thus, the corrosion resistance and reliability of the display panel may be increased.

It is noted that various changes, substitutions and alterations can be made herein without departing from the spirit and scope of the invention.

What is claimed is:

1. A display substrate comprising:
a substrate including a plurality of active areas, each of the active areas having a pixel area in which a plurality of unit pixels is defined and a peripheral area in which a plurality of pads applying signals to the pixel areas is formed;
a guard ring formed on the substrate to enclose each of the active areas, and formed from substantially a same layer as a pixel electrode that is formed in each of the unit pixels; and
a connecting line formed from a different layer than the guard ring, electrically connecting the guard ring with the pads.

2. The display substrate of claim 1, wherein the pixel areas comprise signal lines, and the signal lines comprise:
a gate line formed on the substrate, and formed from a first metal pattern; and
a data line formed on the substrate, and formed from a second metal pattern.

3. The display substrate of claim 2, further comprising:
a first insulating layer formed between the first and second metal patterns; and
a second insulating layer formed between the second metal pattern and the pixel electrode.

4. The display substrate of claim 3, wherein the second insulating layer includes an organic insulating layer.

5. The display substrate of claim 4, wherein the connecting line is formed from the second metal pattern and is formed under the second insulating layer.

6. The display substrate of claim 5, wherein each of the pads comprises:
a first pad layer connected to the connecting line and formed from the second metal pattern; and
a second pad layer formed from substantially the same layer as the pixel electrode and making electrical contact with the first pad layer.

7. The display substrate of claim 6, wherein a first hole is formed through the second insulating layer and the guard ring makes contact with the connecting line through the first hole.

8. The display substrate of claim 4, wherein the connecting line is formed from the first metal pattern and is formed under the second insulating layer.

9. The display substrate of claim 8, wherein each of the pads comprises:
a first pad layer extended from the connecting line and formed from the first metal pattern; and
a second pad layer formed from substantially the same layer as the pixel electrode and making contact with the connecting line and the first pad layer.

10. The display substrate of claim 9, wherein a first hole through which the guard ring makes contact with the connecting line, a second hole through which the connecting line makes contact with the second pad layer and a third hole through which the first pad layer makes contact with the second pad layer are formed through the second insulating layer.

11. The display substrate of claim 8, wherein each of the pads comprises:
a first pad layer extended from the connecting line and formed from the first metal pattern;
a second pad layer formed from the second metal pattern, and making contact with the first pad layer through the first hole formed through the first insulating layer; and
a third pad layer formed from substantially the same layer as the pixel electrode, and making contact with the connecting line and the second pad layer.

12. The display substrate of claim 11, wherein a second hole through which the guard ring makes contact with the connecting line, a third hole through which the connecting line makes contact with the third pad layer and a fourth hole through which the second pad layer makes contact with the third pad layer are formed through the second insulating layer.

13. The display substrate of claim 12, wherein the second metal pattern further comprises:
a first cover pattern corresponding to the second hole and making contact with the connecting line; and
a second cover pattern corresponding to the third hole and making contact with the connecting line.

14. The display substrate of claim 1, wherein each of the pads is a flexible printed circuit (FPC) pad making contact with an FPC.

15. A method for manufacturing a display substrate, the method comprising:
forming a first metal pattern including a gate line on a substrate, an active area having a pixel area and a peripheral area, the active area being defined in the substrate;
forming a first insulating layer on the substrate;
forming a second metal pattern, including a data line, on the first insulating layer;
forming a second insulating layer on the substrate;
forming a guard ring on the second insulating layer, the guard ring enclosing a pixel electrode corresponding to a unit pixel and the active area;
forming pads including a first pad layer in the peripheral area, the first pad layer being formed from at least one of the first or second metal patterns; and
forming a connecting line from a different layer than the guard ring, the connecting line electrically connecting the guard ring with the pads.

16. The method of claim 15, wherein the connecting line is formed from the second metal pattern, and is connected to the first pad layer.

17. The method of claim 15, wherein forming the pads further comprises forming a second pad layer from substantially a same layer as the pixel electrode, and the second pad layer covers the first pad layer.

18. The method of claim 17, further comprising:
forming first and second holes by patterning the second insulating layer, the guard ring making contact with the connecting line through the first hole, the first pad layer making contact with the second pad layer through the second hole.

19. The method of claim 17, wherein the connecting line is formed from the first metal pattern, and is extended from the first pad layer by a predetermined distance.

20. The method of claim 17, further comprising:
forming first, second and third holes by patterning the second insulating layer, the guard ring making contact with the connecting line through the first hole, the connecting line making contact with the second pad layer through the second hole, the first pad layer making contact with the second pad layer through third hole.

21. The method of claim 20, wherein the second metal pattern is formed by:
forming a first cover pattern corresponding to the first hole and making contact with the connecting line; and
forming a second cover pattern corresponding to the second hole and making contact with the connecting line.

22. The method of claim 15, wherein the second insulating layer is formed by forming a passivation layer on the substrate on which the second metal pattern is formed.

23. The method of claim 22, further comprising forming a third insulating layer on the passivation layer.

24. A display apparatus comprising:
a first substrate having a pixel area in which a plurality of unit pixels is defined and a peripheral area in which a plurality of pads applying a signal to the pixel area is formed; and
a connecting line remaining portion of a connecting line connected to each of the pads to extend toward an edge of the first substrate, and being cut at the edge of the first substrate, and the connecting line being formed from a different layer than a guard ring, the guard ring being formed on a motherboard and enclosing the first substrate.

25. The display apparatus of claim 24, wherein the connecting line remaining portion is formed by cutting the guard ring enclosing the first substrate and by cutting the connecting line that electrically connects the pads with each other, by the use of a scribing process.

26. The display apparatus of claim 25, wherein the first substrate further comprises:
a first metal pattern having a gate line;
a first insulating layer formed on the first metal pattern;
a second metal pattern formed on the first insulating layer and having a data line;
a second insulating layer formed on the second metal pattern; and
a pixel electrode corresponding to the unit pixels and formed on the second insulating layer.

27. The display apparatus of claim 26, wherein the connecting line remaining portion is formed from one of the first or second metal patterns and is formed under the second insulating layer.

28. The display apparatus of claim 24, further comprising:
a second substrate corresponding to the pixel area and disposed over the first substrate; and
a liquid crystal layer interposed between the first and second substrates.

29. A display apparatus comprising:
a first display panel on which a driving chip is mounted;
a second display panel including a first connecting line electrically connected to a flexible printed circuit (FPC) pad that is formed at an edge of a data line, a second connecting line spaced apart from the first connecting line and electrically connected to a shorting bar that is formed at an outer area of a base substrate, and a bridge connecting the first connecting line with the second connecting line; and
an FPC board (FPCB) electrically connecting the first display panel with the second display panel, wherein the FPCB is electrically connected to the FPC pad and transmits a driving signal from the driving chip to the second display panel.

30. The display apparatus of claim 29, wherein the first and second connecting lines are formed from a source metal layer that forms the data line.

31. The display apparatus of claim 29, wherein the bridge is formed from a gate metal layer that forms a gate line crossing the data line.

32. The display apparatus of claim 30, wherein the FPC pad comprises:
a metal pad layer formed from the source metal layer and electrically connected to the data line; and
an electric pattern formed on the metal pad layer and making contact with the FPCB.

33. The display apparatus of claim 29, wherein the shorting bar comprises:
a first inspection line electrically connected to an odd-numbered second connecting line that transmits a first inspecting signal to an odd-numbered data line; and
a second inspection line electrically connected to an even-numbered second connecting line that transmits a second inspecting signal to an even-numbered data line, the even-numbered data line being disposed between the odd-numbered data line and an adjacent odd-numbered data line.

34. A display apparatus comprising:
a first display panel on which a driving chip is mounted;
a second display panel including a connecting line electrically connecting a flexible printed circuit (FPC) pad with a shorting bar, the FPC pad having a metal pad layer formed at an edge of a data line and an electrode pattern formed from a transparent conductive layer on the metal pad layer, the shorting bar being formed from the transparent conductive layer at an outer area of the electrode pattern and a base substrate; and
an FPCB electrically connecting the first display panel with the second display panel, wherein the FPCB is electrically connected to the FPC pad, and transmits a driving signal from the driving chip to the second display panel.

35. The display apparatus of claim 34, wherein the second display panel further comprises a pixel electrode formed from the transparent conductive layer.

36. The display apparatus of claim 34, wherein the shorting bar comprises:
a first inspection line electrically connected to an odd-numbered connecting line that transmits a first inspecting signal to an odd-numbered data line; and
a second inspection line electrically connected to an even-numbered connecting line that transmits a second inspecting signal to an even-numbered data line, the even-numbered data line being disposed between the odd-numbered data line and an adjacent odd-numbered data line.
